(19) United States
(12) Patent Application Publication
(10) Pub. No.: US 2023/0169799 A1
(43) Pub. Date: Jun. 1, 2023

(54) Method and Device for Monitoring a Vehicle

(71) Applicant: Bayerische Motoren Werke Aktiengesellschaft, Muenchen (DE)

(72) Inventor: Gustav ZITZEWITZ, Muenchen (DE)

(21) Appl. No.: 17/927,628

(22) PCT Filed: May 10, 2021
(86) PCT No.: PCT/EP2021/062373

§ 371 Date: Nov. 23, 2022

(30) Foreign Application Priority Data
May 26, 2020 (DE) 10 2020 114 115.7

(51) Int. Cl. G07C 5/00; H04W 4/029; G07C 5/08

(52) U.S. Cl. CPC G07C 5/008; H04W 4/029; G07C 5/0841

(57) ABSTRACT

Devices and methods for monitoring a vehicle are provided. An electronic computing device is configured to determine a sequence of positions of the vehicle at a corresponding sequence of times. The device is also configured such that, based on the sequence of positions, the device can determine whether a possible change of ownership of the vehicle has taken place at a time from the sequence of times. The device is also configured to initiate at least one measure relating to the vehicle, if it is determined that a possible change of ownership of the vehicle has taken place.

### BACKGROUND AND SUMMARY OF THE INVENTION

The present subject matter relates to a method and a corresponding device which make it possible to reliably monitor a vehicle, in particular with respect to the ownership status of the vehicle.

A vehicle may possibly change owner several times during the lifetime of the vehicle. In this case, particular rights and/or obligations with respect to the vehicle are typically associated with the ownership of the vehicle. For example, the possibility of remotely accessing the vehicle (for example, in order to read vehicle data, for instance the mileage or the filling level of the fuel tank) should be restricted to the owner of the vehicle. On the other hand, a task of the owner is typically to ensure sufficient maintenance of the vehicle.

The present document deals with the technical object of making it possible to reliably monitor a vehicle, in particular with regard to the ownership status of the vehicle.

Advantageous embodiments are described, inter alia, in the dependent claims. It is pointed out that additional features of a patent claim dependent on an independent patent claim can form a separate invention, which is independent of the combination of all features of the independent patent claim and can be made the subject matter of an independent claim, a divisional application or a subsequent application, without the features of the independent patent claim or only in combination with a subset of the features of the independent patent claim. This applies in the same way to technical teachings which are described in the description and can form an invention that is independent of the features of the independent patent claims.

One aspect describes an electronic computing device for monitoring a (motor) vehicle. The electronic computing device is configured to determine a sequence of positions of the vehicle at a corresponding sequence of times. The positions can be determined using a position sensor (for example using a GPS receiver) of the vehicle. It is therefore possible to determine the positions at which the vehicle was arranged at different (successive) times. The position of the vehicle can be determined once per hour or once per day, for example, and can be indicated in the sequence of times. Alternatively or additionally, it is possible to determine the position of the vehicle at a time at which the vehicle is switched off and/or parked.

The electronic computing device is also configured to determine, on the basis of the sequence of positions, whether a change of ownership of the vehicle has possibly taken place at a time from the sequence of times. For this purpose, the positions from the sequence of positions can be statistically analyzed.

The electronic computing device may be configured, in particular, to respectively assign the positions from the sequence of positions to an interval of time from a plurality of different and/or successive intervals of time. In this case, the individual intervals of time may be so long that an interval of time respectively comprises a plurality of times from the sequence of times. The individual times may therefore be grouped into different (successive) intervals of time. The positions at the different times can then be assigned to the different intervals of time. A corresponding plurality of sets of positions can therefore be provided for the plurality of intervals of time. A set of positions for an interval of time may have, for example, 20 or more or 100 or more or 1000 or more positions (for example for an interval of time of 30 days).

The electronic computing device may also be configured to respectively determine position clusters of the positions assigned to the respective interval of time for each of the plurality of intervals of time using a cluster algorithm (for example, the DBSCAN algorithm). In this case, the positions can be clustered on the basis of one or more cluster parameters. Example cluster parameters are the minimum number of positions per cluster and/or the maximum distance between two positions within a cluster and/or the maximum permissible radius of the position cluster around a center or centroid of the position cluster.

One or more position clusters may therefore be respectively provided for each interval of time. In this case, the individual position clusters indicate positions at which the vehicle was arranged relatively frequently in the respective interval of time.

On the basis of the position clusters for the plurality of intervals of time, it is then possible to determine in a particularly precise manner whether a change of ownership of the vehicle has possibly taken place at a time from the sequence of times.

The electronic computing device therefore makes it possible to determine the ownership status of a vehicle in a precise and reliable manner on the basis of the use, in particular on the basis of the positions, of the vehicle.

The electronic computing device may also be configured to initiate at least one measure with respect to the vehicle if it is determined that a change of ownership of the vehicle has possibly taken place. The electronic computing device may be configured, for example, to initiate, as a measure, an indication with respect to the detected change of ownership being output to a user of the vehicle. The indication may be output, in particular, via a user interface of the vehicle and/or via a user device (for instance, a smartphone) of the user. Outputting an indication makes it possible to check, in particular, whether the detected possible change of ownership of the vehicle has also actually taken place. Furthermore, outputting an indication may cause the actual owner of the vehicle to arrange (possibly required) maintenance of the vehicle.

Alternatively or additionally, the electronic computing device may be configured to initiate, as a measure, remote access to the vehicle by a user device (for instance, a smartphone) of the user, in particular of the previous owner, of the vehicle being checked and/or automatically prevented. The security of the operation of the vehicle than can thus be increased. In particular, possibly impermissible remote access to the vehicle can thus be prevented.

The electronic computing device may be configured to determine a degree of overlap of the position clusters for a pair of directly successive intervals of time. The degree of overlap of the position clusters for a pair of directly successive intervals of time may be determined in this case, for example, on the basis of the number of position clusters for the different intervals of time which overlap. Alternatively or additionally, the degree of overlap may be determined on the basis of the degree of overlap of position clusters for the different intervals of time. In order to determine the degree of overlap of two position clusters, both position clusters can be considered to be circles having a particular radius around a respective cluster center, for example. The degree of overlap of the two circles can then be determined.

The electronic computing device may also be configured to determine, on the basis of the degree of overlap of the position clusters, whether a change of ownership of the vehicle has possibly taken place between the directly successive intervals of time. In particular, the electronic computing device may be configured to compare the determined degree of overlap of the position clusters for a pair of directly successive intervals of time with an overlap threshold value. It is then possible to determine, in a particularly precise manner, on the basis of the comparison, whether a change of ownership of the vehicle has possibly taken place between the directly successive intervals of time.

The electronic computing device may be configured to determine a degree of overlap of the position clusters for each pair of directly successive intervals of time from the plurality of intervals of time. It is then possible to reliably determine, on the basis of the degree of overlap of the position clusters for the different pairs of directly successive intervals of time, between which intervals of time from the plurality of intervals of time a change of ownership of the vehicle has possibly taken place.

The electronic computing device may be configured to subdivide the sequence of times into intervals of time of a particular duration (for example 1 month) in order to determine the plurality of intervals of time. Furthermore, the electronic computing device may be configured to change the duration of the intervals of time in order to determine different pluralities of intervals of time each with different durations. Different intervals of time with different durations (for example 2 weeks, 1 month, 2 months) can therefore be considered.

Position clusters for the different pluralities of intervals of time can then be respectively determined (on the basis of the sequence of positions). Furthermore, it is possible to determine, on the basis of the position clusters for the different pluralities of intervals of time, whether a change of ownership of the vehicle has possibly taken place at a time from the sequence of times. The reliability with which a change of ownership is detected can be increased further by considering intervals of time of different lengths.

A further aspect describes a (road) motor vehicle (in particular, an automobile or a truck or a bus or a motorcycle) which comprises the electronic computing device described in this document.

A further aspect describes a vehicle-external unit which comprises the electronic computing device described in this document. The electronic computing device may be configured to monitor a multiplicity of different vehicles (in each case on the basis of a sequence of positions for the respective vehicle) (in particular with respect to the ownership status of the respective vehicle).

A further aspect describes a method for monitoring a (motor) vehicle. The method comprises determining a sequence of positions of the vehicle at a corresponding sequence of times. The method also comprises determining, on the basis of the sequence of positions, whether a change of ownership of the vehicle has possibly taken place at a time from the sequence of times. The method may also comprise causing at least one measure with respect to the vehicle if it is determined that a change of ownership of the vehicle has possibly taken place.

A further aspect describes a software (SW) program. The SW program may be configured to be executed on a processor and to thereby carry out the method described in this document.

A further aspect describes a storage medium. The storage medium may comprise a SW program which is configured to be executed on a processor and to thereby carry out the method described in this document.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways.

### BRIEF DESCRIPTION OF THE DRAWINGS

FIG. 1 shows example components of a vehicle.

FIG. 2A shows example position data relating to a vehicle.

FIG. 2B shows example position data relating to a vehicle.

FIG. 3 shows a flowchart of an example method for monitoring a vehicle.

### DETAILED DESCRIPTION

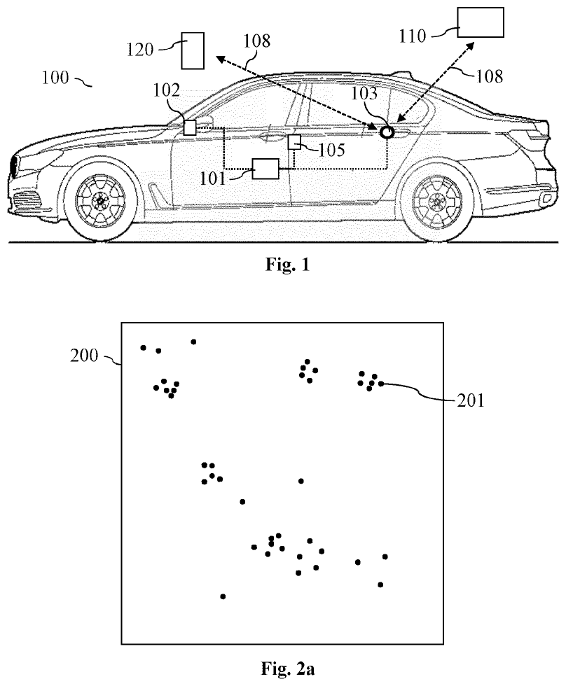

As stated at the outset, the present document deals with the reliable monitoring of a vehicle, in particular with respect to the ownership status of the vehicle. In this context, FIG. 1 shows an example vehicle 100 having a position sensor 105 (for example having a GPS receiver) which is configured to capture position data (that is to say sensor data) with respect to the position of the vehicle 100.

An electronic control unit 101 of the vehicle 100 may be configured to determine a sequence of positions of the vehicle 100 on the basis of the position data for a sequence of times. It is therefore possible to determine the positions at which the vehicle 100 was arranged at different times. The positions may be, for example, positions within a digital map of a road network. The position of the vehicle 100 can be determined at a particular sampling rate (for example one position per hour or per day).

The sequence of positions can be transmitted to a electronic computing (vehicle-external) evaluation device 110 using an electronic communication unit 103 of the vehicle 100 via a (wireless) communication connection 108. The evaluation device 110 may be configured to determine, on the basis of the sequence of positions and on the basis of the time specifications for the different positions, whether or not a change of ownership has (possibly) taken place. In particular, a hypothesis for a possible change of ownership can be created on the basis of the temporal sequence of positions. For example, it is possible to determine that a change of ownership has taken place with a probability of x % (for example x=50 or more or 70 or more).

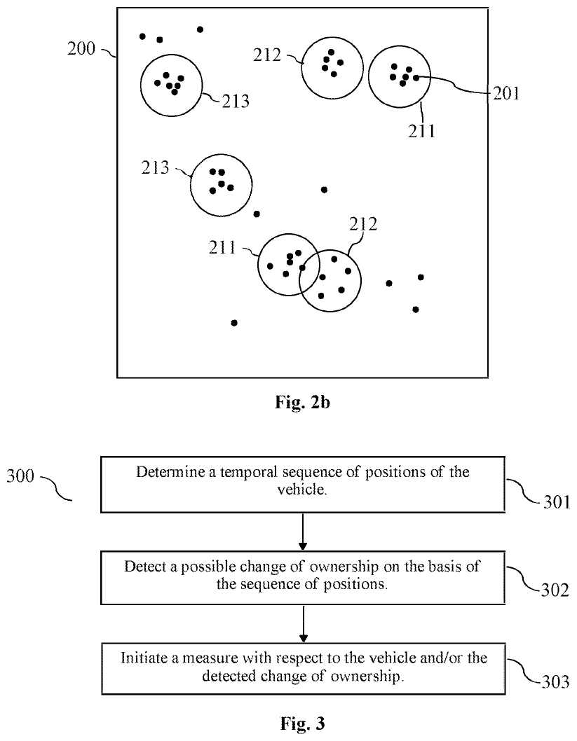

FIG. 2a shows an example digital map 200 in which the different positions 201 of the vehicle 100 are recorded. As is clear from FIG. 2a, the distribution of the positions 201 of a vehicle 100 typically has one or more accumulations (for example at the residence or place of work of the owner of the vehicle 100). The evaluation device 110 may be configured to apply a cluster algorithm to the temporal sequence of positions 201 of the vehicle 100. An example cluster algorithm is the DBSCAN algorithm.

In this case, the temporal sequence of positions 201 can be clustered separately for different intervals of time. In particular, the sequence of positions 201 or the sequence of times may be subdivided into different (directly successive) intervals of time. An interval of time may have a duration of 30 days, for example. The different positions 201 (with the respective time specification) can then be divided into different sets of positions 201 for different intervals of time.

Local clustering of the positions 201 can then be carried out for each interval of time for the respective set of positions 201. In this case, one or more cluster parameters can be taken into account, for example

the maximum permissible distance between the positions 201 in a cluster; and/or

the minimum required number of positions 201 within a cluster; and/or

the maximum permissible radius of a cluster around a center of the cluster or the maximum permissible distance of a position 201 in a cluster from the center of the cluster.

FIG. 2b shows example position clusters 211, 212, 213 for different intervals of time. In particular, FIG. 2b shows first position clusters 211 for a first interval of time, second position clusters 212 for a second interval of time and third position clusters 213 for a third interval of time, wherein the second interval of time (directly) follows the first interval of time, and wherein the third interval of time (directly) follows the second interval of time.

The evaluation device 110 may be designed to determine, on the basis of the position clusters 211, 212, 213, whether or not a change of ownership of the vehicle 100 has taken place. In particular, a hypothesis for a change of ownership having taken place (for example with a particular probability) can be created on the basis of the position clusters 211, 212, 213.

The evaluation device 110 may be configured, in particular, to compare the position clusters 211, 212, 213 for two directly successive intervals of time with one another. In particular, it is possible to check whether or not position clusters 211, 212, 213 for two directly successive intervals of time overlap. For example, the degree of overlap of the position clusters 211, 212, 213 for two directly successive intervals of time can be determined. In this case, the degree of overlap may depend on

the number of position clusters 211, 212, 213 of the different intervals of time for which there is an overlap; and/or

the degree of overlap of the position clusters 211, 212, 230 for the different intervals of time.

On the basis of the degree of overlap of the position clusters 211, 212, 213 for two directly successive intervals of time, it is then possible to determine whether or not a change of ownership has taken place between the two intervals of time, or a hypothesis for a change of ownership can be created.

The evaluation device 110 may be configured to vary (for example extend and/or shorten) the temporal length of the intervals of time under consideration. The position clusters 211, 212, 213 can then be determined for intervals of time of different lengths. Furthermore, it is respectively possible to check, on the basis of the position clusters 211, 212, 213, whether a change of ownership has (possibly) taken place and between which intervals of time the change of ownership has taken place. The accuracy with which a hypothesis for a change of ownership is determined can be increased by varying the temporal length of the intervals of time. In particular, time-limited usage changes of the vehicle 100 (for example during a vacation trip) and associated incorrect detection of a change of ownership can therefore be detected and eliminated.

The evaluation device 110 may also be configured to carry out one or more measures with respect to the vehicle 100 if there is a hypothesis for a change of ownership and/or after a possible change of ownership has been detected. In particular, it is possible to initiate an indication being output to the user of the vehicle 100 in order to check whether a change of ownership has actually taken place. For example, it is possible to initiate an indication being output via a user interface 102 (for example on a screen and/or via a loudspeaker of the vehicle 100). The user of the vehicle 100 may be requested, for example by the indication, to confirm whether or not a change of ownership has actually taken place. Furthermore, the user of the vehicle 100 may be requested to carry out maintenance of the vehicle 100.

Alternatively or additionally, remote access to the vehicle 100 may be blocked or at least checked after a possible change of ownership has been detected. Remote access makes it possible, for example, for the owner of the vehicle 100 to access the vehicle 100 via a user device 120 (for example a smartphone). In this case, vehicle information, for instance the mileage of the vehicle 100 and/or the filling level of the energy store of the vehicle 100, may be requested, for example. Furthermore, it may possibly be possible for the owner to lock and/or unlock the vehicle 100 or to open or close a window of the vehicle 100.

The evaluation device 110 may be configured to automatically block remote access to the vehicle 100 in response to a detected possible change of ownership. In this case, an indication of the user device 120 of the previous owner may be transmitted to the previous owner in order to inform the previous owner that remote access has been blocked for security reasons on account of a detected possible change of ownership. Furthermore, it may be possible for the previous owner (possibly only after checking the ownership status, for instance by presenting the vehicle registration) to enable remote access again. Automatically determining a possible change of ownership therefore enables particularly secure operation of a vehicle 100.

FIG. 3 shows a flowchart of an example (possibly computer-implemented) method 300 for monitoring a vehicle 100. The method 300 is designed, in particular, to monitor the ownership status of the vehicle 100.

The method 300 comprises determining 301 a sequence of positions 201 of the vehicle 100 at a corresponding sequence of times. The sequence of positions 201 can be determined, for example, using a position sensor 105 of the vehicle 100. The times in the sequence of times may be equidistant (for example with an interval of time of one or more hours or a day). Alternatively or additionally, the times may be times at which the vehicle 100 is switched off and/or parked.

The method 300 also comprises determining 302, on the basis of the sequence of positions 201, whether a change of ownership of the vehicle 100 has possibly taken place at a time from the sequence of times. In particular, on the basis of position clusters 211, 212, 213 of the positions 201 for different intervals of time, it is possible to check whether a change of ownership has possibly taken place between two intervals of time. The individual intervals of time may each comprise, for example, 100 or more times or positions 201 from the sequence of times or from the sequence of positions 201.

The method 300 may also comprise causing 303 at least one measure with respect to the vehicle 100 if it is determined that a change of ownership of the vehicle 100 has possibly taken place. In this case, an indication may be output to the previous owner of the vehicle 100 and/or remote access to the vehicle 100 may be checked and/or prevented as a measure, for example.

The measures described in this document may make it possible to reliably monitor a vehicle 100, in particular with respect to the ownership status.

The present subject matter is not restricted to the examples shown. In particular, it should be noted that the description and the figures are intended to illustrate the principle of the proposed methods, devices and systems merely by way of example.

1.-10. (canceled)

11. An electronic computing device for monitoring a vehicle, comprising:
a processor;
a memory in communication with the processor and storing instructions to configure the device to:
determine a sequence of positions of the vehicle at a corresponding sequence of times;
determine, based on the sequence of positions, whether a change of ownership of the vehicle has taken place at a time from the sequence of times; and
initiate at least one measure with respect to the vehicle in response to the determination that a change of ownership of the vehicle has taken place.

12. The device according to claim 11, wherein the memory further stores instructions to configure the device to:
respectively assign the positions from the sequence of positions to an interval of time from a plurality of intervals of time, wherein
an interval of time respectively comprises a plurality of times from the sequence of times;
respectively determine position clusters of the positions assigned to the respective interval of time for each of the plurality of intervals of time using a cluster algorithm; and
determine, based on the position clusters for the plurality of intervals of time, whether a change of ownership of the vehicle has taken place at a time from the sequence of times.

13. The device according to claim 12, wherein the memory further stores instructions to configure the device to:
determine a degree of overlap of the position clusters for a pair of directly successive intervals of time; and
determine, based on the degree of overlap of the position clusters, whether a change of ownership of the vehicle has taken place between the directly successive intervals of time.

14. The device according to claim 13, wherein the memory further stores instructions to configure the device to:
determine a degree of overlap of the position clusters for each pair of directly successive intervals of time from the plurality of intervals of time; and
determine, based on the degree of overlap of the position clusters for the pairs of directly successive intervals of time, between which intervals of time from the plurality of intervals of time a change of ownership of the vehicle has taken place.

15. The device according to claim 13, wherein the memory further stores instructions to configure the device to:
determine the degree of overlap of the position clusters for a pair of directly successive intervals of time:
based on a number of position clusters for the intervals of time which overlap; and/or
based on a degree of overlap of position clusters for the intervals of time.

16. The device according to claim 13, wherein the memory further stores instructions to configure the device to:
compare the determined degree of overlap of the position clusters for a pair of directly successive intervals of time with an overlap threshold value; and
determine, based on the comparison, whether a change of ownership of the vehicle has taken place between the directly successive intervals of time.

17. The device according to claim 12, wherein the memory further stores instructions to configure the device to:
subdivide the sequence of times into intervals of time of a particular duration in order to determine the plurality of intervals of time;
change the duration of the intervals of time to determine different pluralities of intervals of time each with different durations;
determine position clusters for the different pluralities of intervals of time; and
determine, based on the position clusters for the different pluralities of intervals of time, whether a change of ownership of the vehicle has taken place at a time from the sequence of times.

18. The device according to claim 11, wherein the memory further stores instructions to configure the device to:
initiate an indication with respect to the determined change of ownership being output to a user of the vehicle via a user interface of the vehicle and/or via a user device of the user.

19. The device according to claim 11, wherein the memory further stores instructions to configure the device to:
initiate remote access to the vehicle by a user device of a previous owner of the vehicle being checked and/or automatically prevented.

20. A method for monitoring a vehicle comprising:
determining a sequence of positions of the vehicle at a corresponding sequence of times;
determining, based on the sequence of positions, whether a change of ownership of the vehicle has taken place at a time from the sequence of times; and
causing at least one measure with respect to the vehicle in response to the determining that a change of ownership of the vehicle has taken place.
